(19) United States
(12) Patent Application Publication
(10) Pub. No.: US 2005/0114014 A1
(43) Pub. Date: May 26, 2005

(54) System and method to notify a person of a traveler's estimated time of arrival

(76) Inventor: Emad S. Isaac, Woodridge, IL (US)

Correspondence Address: Motorola Energy Systems Group, 1700 Belle Meade Court, Lawrenceville, GA, 30043, US

(21) Appl. No.: 10/723,131

(22) Filed: Nov. 24, 2003

(51) Int. Cl. G01C 21/30

(52) U.S. Cl. 701/204; 701/200

(57) ABSTRACT

A system and method of calculating an estimated time of arrival for a traveler is provided, along with a notification of this estimated time that is sent to a third party. The traveler is equipped with a navigation unit having a global positioning sensor and a wireless communications device. The navigation unit communicates with a service center equipped with a server capable of generating a preferred navigational route for the traveler. The service center also includes a traffic database for maintaining current traffic information. Once the traveler has selected a predetermined time and frequency of notifications based upon a selected criterion, the navigation unit transmits the traveler's position and velocity to the service center. The service center then calculates the estimated time of arrival based upon the traveler's position, velocity, distance to be traveled and traffic and weather conditions. Once this time is calculated, the service center sends a notification to the third party.

### BACKGROUND

1. Technical Field

This invention relates generally to vehicular navigational systems, and more particularly to a system for determining a traveler's estimated time of arrival and then notifying a third party.

2. Background Art

Navigational systems are becoming more and more popular. Gone are the days of traveling with only the guidance of the stars. Today's traveler has access to sophisticated navigational equipment to help them journey from point A to point B. These systems, be they mounted in a vehicle or simply in a handheld device, employ sophisticated electronics like global positioning system (GPS) sensors to tell travelers who are unfamiliar with the local geography not only exactly where they are, but also how to get from a starting point to a destination point. Additionally, some navigational systems are capable of providing a driver with a visual map.

Conventional navigational systems generally provide only directional and distance information to the traveler. The navigational unit generally has an interactive visual screen or buttons that allows a driver to enter a starting point and destination point into the navigational system. The navigation unit then turns to a memory or CD drive that keeps map data. A local computer processor generates textual directions (e.g., “Drive for one mile and then turn right . . . ”, etc.) based on the map data and desired destination, and displays these directions, in addition to present latitude and longitude coordinates, on the screen. From this information, the traveler can determine where to turn and how far he has to go.

The problem with this distance and directional information is that it does not translate to one's schedule or itinerary very well. For example, in large, metropolitan cities like Atlanta, people do not conversationally measure distances in units of length. They rather talk of distances in units of time, so as to better correlate travel and itinerary. For instance, a person might ask, “How far is it from downtown to the airport?” Another might respond, “It's about 20 minutes, without traffic,” meaning that it will take the traveler, on average, 20 minutes to get from downtown to the airport. When a navigational system provides only distances, it is difficult for a traveler, or the party he's meeting, to determine how long it will take to get there, or when he will arrive.

One prior art solution to this “when will he arrive” problem is to use the known speed limits on the roads to calculate an estimated time of arrival. For example, if the navigational system knows that the traveler will travel for 10 miles on a road with a 55 m.p.h. speed limit, then 1 mile on a road with a 35 m.p.h. speed limit and another mile on a road with a 25 m.p.h. speed limit, it is trivial to determine that a traveler driving at the speed limit will arrive in approximately 10 minutes. The problem with this prior art is that one wreck on the 55 m.p.h. road may turn this 10 minute trip into a 2 hour trip.

There is thus a need for an improved navigational system capable of providing an accurate, estimated time of arrival to a user.

### BRIEF DESCRIPTION OF THE DRAWINGS

FIG. 1 is a top-level block diagram of one embodiment of a navigation system of the present invention;

FIG. 2 is a block diagram of the navigation system in FIG. 1 showing further details of one embodiment of a service center of the system.

FIG. 3 is a map illustrating the selection by the service center of certain points along a route used in the navigation system of the present invention.

FIG. 4 is a flow diagram illustrating one embodiment of operations between the navigation unit and the service center in the navigation system of the present invention.

FIG. 5 is a block diagram of the navigation system in FIG. 1 showing further details of one embodiment of a navigation unit of the system.

FIG. 6 illustrates a summary of the operation and interaction between the navigation unit and the service center in accordance with one embodiment of present invention.

FIG. 7 illustrates one embodiment of the method of determining the estimated time to arrival in accordance with the invention.

FIG. 8 illustrates one method for calculating the estimated time of arrival.

### DETAILED DESCRIPTION OF THE INVENTION

A preferred embodiment of the invention is now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.”

This invention provides a system and method for determining a traveler's estimated time of arrival at a particular destination. The system is capable of alerting a third party, at programmable, predetermined intervals, when the traveler will arrive. For example, if a family member is arriving at the airport and then traveling to meet the family at home, the system provides a means of telephoning, paging, e-mailing or otherwise notifying the family of the member's estimated arrival time. The estimated time of arrival is based on several criteria, including position of the vehicle, velocity of the vehicle, selected course of travel, and traffic and weather conditions.

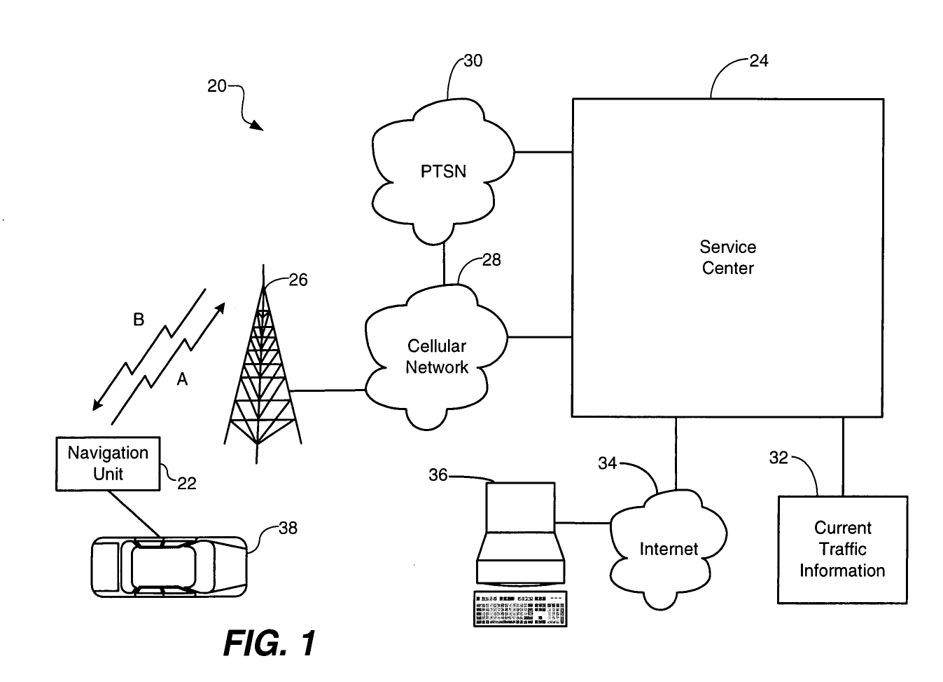

While it will be understood by those of ordinary skill in the art that the estimated time to arrival notification system of the present invention may be employed with a variety of navigational systems, for discussion purposes, one preferred embodiment of a networked navigational system will be described herein, as illustrated in FIG. 1.

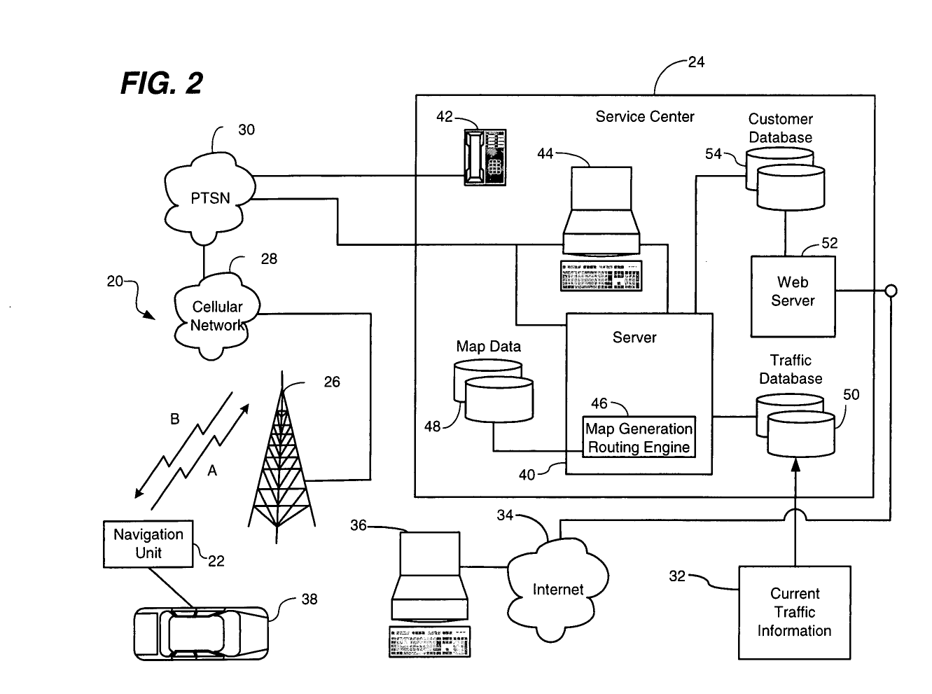

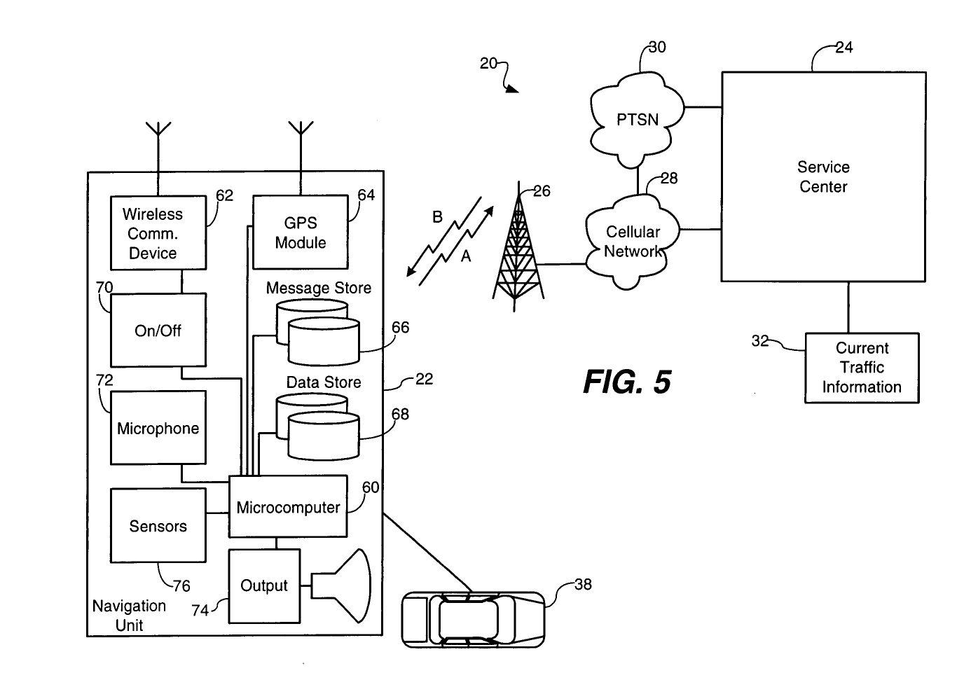

Referring now to FIG. 1, illustrated therein is a top-level block diagram of one navigational system 20 with which the present invention may be used. Generally, the navigation system 20 includes a navigation unit 22 and a service center 24. The service center 24 and the navigation unit 22 are described further below in relation to FIGS. 2 and 5, respectively.

In the navigation system 20, the navigation unit 22 and the service center 24 may communicate with each other via wireless communications. The wireless communications are illustrated in FIG. 1 by communication arrows A and B. The communications between the navigation unit 22 and the service center 24 will now be described generally although a more detailed description is provided after the general discussion.

Generally, in one embodiment, the navigation unit 22 transmits its current location (or starting point) and desired location (or destination point) to the service center 24 via communication A. As shown in FIG. 1, in one embodiment, the communication A is a cellular wireless communication that is transmitted to a base station antenna 26, through a cellular network 28 and a public switched telephone network (PSTN) 30, and to the service center 24. The transmission of the destination point to the service center 24 may be a voice call to an operator at the service center 24 that is initiated by the user of the navigation unit 22. The starting point may be transmitted during the voice call or determined by a global positioning system (GPS) module in the navigation unit 22 and transmitted separately. Alternatively, the transmission of the starting point and destination point to the service center 24 may be a data transmission manually or otherwise entered by the user of the navigation unit 22. Note that the term “global positioning system” and the acronym “GPS” as used herein shall refer to any type of satellite or terrestrial device capable of transmitting geographical position coordinates to a portable device. This includes traditional global positioning systems, as well as new technologies like the Galileo system in the European Union, LORAN, Glonass, and other equivalent systems.

Those of ordinary skill in the art, having the benefit of this disclosure, will appreciate that many possible wireless communication methods may be used for communications from the navigation unit 22 to the service center 24. In one embodiment, the communications are via a cellular wireless communication such as AMPS, CDMA, GSM or TDMA. The transmission from the navigation unit 22 to the service center 24 may also be made by other wireless communications such as a satellite communications.

In response to receiving the starting point and destination point from the navigation unit 22, the service center 24 selects a route and determines a variety of points along the route. These points may include preparation points, warning points, instruction points, confirmation points, maneuver points and other points. The points are transmitted from the service center 24 to the navigation unit 22.

The service center 24 has a server that uses digital map data to select a route. The service center 24 may also be configured to receive current traffic and weather information 32 from a service provider or other current traffic or weather source. In that case, the selected route may also include a consideration for current traffic or weather patterns. After selecting a route, the server then determines various points along the route to help instruct the user toward the destination point.

As shown in FIG. 1, in one embodiment, the communication B is a cellular wireless communication that is sent through the public switched telephone network (PSTN) 30 and cellular network 28 and transmitted by the base station antenna 26 to the navigation unit 22. Again, those of ordinary skill in the art, having the benefit of this disclosure, will appreciate that many possible wireless communication methods may be used for communications from the service center 24 to the navigation unit 22. In one embodiment, the communication is via a digital cellular wireless communication such as CDMA, GSM or TDMA. The transmission from the service center 24 to the navigation unit 22 may also be made by other wireless communication such as a satellite communications.

Generally, the navigation unit 22 consists of a wireless communication module and antenna for transmitting and receiving wireless voice and data communications to and from the service center 24. The navigation unit 22 further includes a microcomputer for performing the main functions of processing the various points received from the service center 24. The navigation unit 22 includes a screen for displaying information to a user.

Additionally, the navigation system 20 may be set up to allow a user of a navigation unit 22 to access the service center 24 via the Internet 34 and a remote device 36. From the remote device 36, a user can customize route selection and tracking information. For example, from remote device 36, the user could require that route selection include or not include the consideration of current traffic or weather information. Moreover, from remote device 36, the user could select the type of data and information downloaded from the service center 24 to the navigation unit 22. This may include the desire to have additional preparation or warning points or remove certain downloaded points. This may also include the selection, activation or deactivation of certain preferred voice or text messages. The connection to the service center 24 may also be configured to allow the user to access user profile information and billing information records.

Referring now to FIG. 2, the service center 24 of the navigation system 20 will now be described in more detail. At the heart of the service center 24 is a server 40. The service center 24, through server 40, performs several functions including receiving the starting point and destination point, selecting a route based on the received locations, determining certain maneuver points along the selected route, and transmitting data associated with the determined points to the navigation unit 22.

As stated, one function of the service center 24 is to receive the starting point and destination point transmitted by the navigation unit 22. Accordingly, in one embodiment, the service center 24 may further include at least one telephone 42 and at least one computer terminal 44. In this embodiment, an operator at the service center 24 may use the telephone 42 to receive voice communications from the user of the navigation unit 22. During the voice communication, the user of the navigation unit 22 can provide the operator with the starting point and destination point. The operator may then enter, or otherwise input, the starting point and destination point into the computer terminal 46. In this embodiment, the server 40 receives the starting point and destination point from the computer terminal 46. Alternatively, in another embodiment, the navigation unit 22 may be configured to directly transmit the starting point and/or destination point to the server 40 via a digital transmission. For example, a GPS module may determine the starting point of the navigation unit 22 and a wireless communication device in the navigation unit 22 can digitally transmit that information to the server 40 using a cellular communication. The navigation unit 22 could also be configured to allow the user to type or otherwise manually enter the destination point. The entered destination point could be encoded and transmitted to the server 40 via a digital transmission.

Another function of the service center 24 is to select a route based on the received starting and destination points. The server 40 in the service center 24 uses a map generation routing engine 46 to select a route. The map generation routing engine 46 may be a separate component or integral to the server 40. The server 40 uses the map generation routing engine 46 to select a route based on the received starting and destination points. Connected to the map generation routing engine 46 is stored digital map data 48 that is used to select a route from the starting point to the destination point. The service center 24 may optionally be configured to receive current traffic or weather information 32.

Route selection may also consider previously selected preferences by the user of the navigation unit 22. In one embodiment, the service center 24 further includes a web server 52 and a customer database 54. The web server 52 is connected to the Internet 34 to allow the user to access the service center 24 via a remote device 36. For example, from remote device 36, the user could require that route selection include or not include the consideration of current traffic information. Information received through web server 52 is stored and updated in the customer database 54. The server 40 may be connected to the customer database 54 to allow the server 40 to access the customer database during route selection.

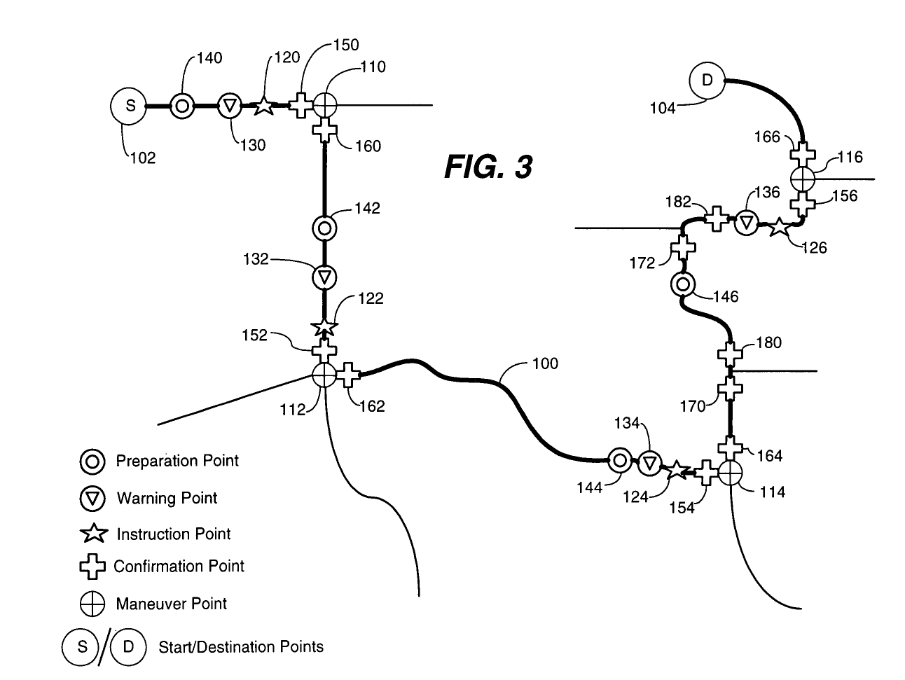

A further function of the service center 24 is to determine certain points after the route is selected. The details of these determined points by the server 40 are further explained with reference to FIG. 3. FIG. 3 graphically illustrates a map having a dark line that represents a route 100 selected as described above. The selected route 100 extends from a starting point 102 to a destination point 104. As will be explained in more detail below, the server 40 determines various sets of points along the route 100. As those skilled in the art will appreciate, each point along the route represents a specific purpose along the route.

In one embodiment, the server 40 determines a set of maneuver points 110, 112, 114, 116 along the selected route 100. The maneuver points 110, 112, 114, 116 represent points along the selected route 100 where a maneuver must be taken by the user of the navigation unit 22 to properly progress along to reach the destination point 104. In one embodiment, the maneuver points 110, 112, 114, 116 are simply used to determine other points along the selected route 100 and not themselves downloaded to the navigation unit 22. However, depending on the specific implementation, the maneuver points 110, 112, 114, 116 could be downloaded to the navigation unit 22.

The server 40 may also determine a set of instruction points 120, 122, 124, 126. Each instruction point 120, 122, 124, 126 is positioned prior to each maneuver point 110, 112, 114, 116, respectively. These instruction points 120, 122, 124, 126 are intended to provide final instructions to the user of the navigation unit 22 to perform a maneuver. In determining each point, the server 40 may generate data associated with each point such as a set of coordinates and a message that can be outputted to the user. In one embodiment, token numbers may be used to form the message associated with a point. The token numbers are representative of a string of voice or text words and phrases to be outputted to the user of the navigation unit 22 when the user of the navigation unit 22 reaches the set of coordinates of the instruction point 120, 122, 124, 126. For example, when the user of the navigation unit 22 comes within a predetermined radius of the coordinates of instruction point 120, the user may be provided with a voice or text message such as “Please turn right.” Instruction points 122, 124, 126 may provide the user of the navigation unit 22 with a voice or text message such as “Please turn left.” Additionally, the server 40 may generate data associated with each point that includes the type of point (i.e. instruction point), the type of maneuver, the name of the street to turn on to, a graphic representation of the maneuver, and the like.

In cases where multiple maneuvers are very close together, the spoken instructions may become more complex. For example, an instruction point (not shown) may provide the following instructional message to the user of the navigation unit 22: “Please turn right and then left.” This may be important when the distance between maneuver points is limited and the messages of various points can be combined. In this way, the user of the navigation unit 22 can follow the instructions for two or more maneuvers at one time. Moreover, a maneuver for more complex operations such as a roundabout may have a message such as “Please take the third exit of the roundabout.” A maneuver that takes a user off an expressway may have a message such as “Please exit the expressway.”

The server 40 may also determine a set of warning points 130, 132, 134, 136. Each warning point 130, 132, 134, 136 is positioned prior to each maneuver point 110, 112, 114, 116, respectively. These warning points 130, 132, 134, 136 are intended to provide a warning to the user of the navigation unit 22 that a maneuver is coming up. The distance between the warning points 130, 132, 134, 136 and the maneuver points 110, 112, 114, 116 is greater than the distance between the instruction points 120, 122, 124, 126 and the maneuver points 110, 112, 114, 116.

In determining each point, the server 40 may generate data associated with each warning point 130, 132, 134, 136 such as a set of coordinates and a message to be outputted to the user. In one embodiment, token numbers are used to represent a string of voice or text words and phrases that form a message to be outputted to the user of the navigation unit 22 when the user of the navigation unit 22 reaches the set of coordinates of the warning points 130, 132, 134, 136. For example, warning point 130 may provide the user of the navigation unit 22 with a voice or text message such as “In (250 meters) turn right.” Warning points 132, 134, 136 may provide the user of the navigation unit 22 with a voice or text message such as “In (250 meters) turn left.”Additionally, the server 40 may generate data associated with each point that includes the type of point (i.e. warning point).

It is preferred that a distinction be made between the various speed classes of roadways so that the various warning points 130, 132, 134, 136 can be placed at appropriate distances to give the user of the navigation unit 22 enough time to react to the voice or text messages. For example, a warning point on a road with a high-speed class would be positioned farther from the maneuver point than a warning point on a road with a low speed class. Accordingly, the service center 24 may further include as part of the stored digital map data 48 information on the various speed classes of the roadways. The server 40 along with the map generation routing engine 46 can then use the various speed classes to appropriate position of the warning points 130, 132, 134, 136. As those skilled in the art will appreciate, having the benefit of this disclosure, the selection of distances between the warning points 130, 132, 134, 136 and associated maneuver points 10, 112, 114, 116 as well as the outputted voice or text messages are implementation specific. Speed class also can affect the position or location of instruction points.

The server 40 may further determine a set of preparation points 140, 142, 144, 146. Each preparation point 140, 142, 144, 146 is positioned prior to each maneuver point 110, 112, 114, 116, respectively. These preparation points 140, 142, 144, 146 are intended to prepare the user of the navigation unit 22 that a maneuver is coming up.

Similar to the other points, the server 40 may generate data associated with each preparation point 140, 142, 144, 146 such as a set of coordinates and a message to be outputted to the user. In one embodiment, the token numbers may be used that represent a string of voice or text words and phrases that form a message to be outputted to the user of the navigation unit 22 when the user of the navigation unit 22 reaches the set of coordinates of the preparation points 140, 142, 144, 146. For example, preparation point 140 may provide the user of the navigation unit 22 with a voice or text message such as “Prepare to turn right in (500 meters).” Preparation points 142, 144, 146 may provide the user of the navigation unit 22 with a voice or text message such as “Prepare to turn left in (500 meters).” Additionally, the server 40 may generate data associated with each point that includes the type of point (i.e. preparation point), the type of maneuver, the name of the street to turn on to, a graphic representation of the maneuver, and the like.

It is preferred that a distinction is also made between the various speed classes of roadways so that the various preparation points 140, 142, 144, 146 can be placed at appropriate distances to give the user of the navigation unit 22 enough preparation to react to the voice or text messages. For example, a preparation point on a road with a high-speed class would be positioned farther from the maneuver point than a preparation point on a road with a low speed class. Accordingly, the service center 24 may further include as part of the stored digital map data 48 information on the various speed classes of the roadways. The server 40 along with the map generation routing engine 46 can then use the various speed classes to determine the appropriate position or location of the preparation points 140, 142, 144, 146. As those skilled in the art will appreciate, having the benefit of this disclosure, the selection of distances between the preparation points 140, 142, 144, 146 and associated maneuver points 110, 112, 114, 116 as well as the outputted voice or text messages are implementation specific.

The server 40 may further determine a set of confirmation points. In one embodiment, separate sets of confirmation points are placed before and after every maneuver point. Each set of confirmation points at a maneuver point has a first confirmation point 150, 152, 154, 156 and a second confirmation point 160, 162, 164, 166. The first confirmation points 150, 152, 154, 156 are positioned just prior to maneuver points 110, 112, 114, 116, respectively. The second confirmation points 160, 162, 164, 166 are positioned just after maneuver points 110, 112, 114, 116, respectively. These confirmation points are positioned to confirm that the user of the navigation unit 22 is properly traveling to its destination point.

As will be explained in more detail below, after reaching a first confirmation point 150, 152, 154, 156, the navigation unit 22 then monitors the current location of the navigation unit 22 for a predetermined time period or predetermined measured distance traveled until the navigation unit 22 reaches the associated second confirmation point 160, 162, 164, 166. By passing through a first confirmation point 150, 152, 154, 156 and then passing through an associated second confirmation point 160, 162, 164, 166, respectively, the navigation unit 22 knows that the user is still traversing on the selected route. However, when the navigation unit 22 passes through a first confirmation point 150, 152, 154, 156 but fails to pass through an associated second confirmation point 160, 162, 164, 166, respectively, within a predetermined time period or predetermined measured distance traveled, the navigation unit 22 knows that the user has gone off course. If this occurs, the navigation unit 22 may then provide a warning to the user.

The server 40 may generate data associated with each confirmation point such as the type of point (i.e. first or second confirmation point) and a set of coordinates that position the confirmation points along the selected route. In one embodiment, certain confirmation points may further include token numbers that represent a string of voice or text words and phrases that form a message to be outputted to the user of the navigation unit 22. The message may provide a confirmation or reassurance to the user of the navigation unit 22 that the user is traversing properly along the selected route 100. For example, in addition to a set of coordinates, the second confirmation point 160 may include token numbers that represent a string of voice or text words and phrases to be outputted to the user of the navigation unit 22 when the user of the navigation unit 22 reaches the second confirmation point 160. A suitable voice or text message may include “Continue to follow the road for (1000 meters).”

To further minimize the amount of data transmitted to the navigation unit 22, in an alternative embodiment, the first confirmation points 150, 152, 154, 156 may be substituted with the instruction points 120, 122, 124, 126. In other words, when the navigation unit 22 passes through an instruction point 120, 122, 124, 126, the navigation unit 22 then monitors the current location of the navigation unit 22 for a predetermined time period or predetermined measured distance traveled until the navigation unit 22 reaches an associated confirmation point 160, 162, 164, 166. By passing through an instruction point 120, 122, 124, 126 and then through an associated confirmation point 160, 162, 164, 166, respectively, the navigation unit 22 knows that the user is still traversing on the selected route. However, in this alternative embodiment, when the navigation unit 22 passes through an instruction point 120, 122, 124, 126, but fails to pass through an associated confirmation point 160, 162, 164, 166, respectively, within a predetermined time period or predetermined measured distance traveled, the navigation unit 22 knows that the user has gone off course. If this occurs, the navigation unit 22 may then provide a warning to the user.

In addition to confirmation points associated with maneuver points, a separate set of confirmation points may also be placed before and after every intersection where there is an opportunity for the user of the navigation unit 22 to leave the selected route 100. For example, FIG. 3 shows separate sets of confirmation points 170, 172, 180, 182 at every intersection along the route where there is an opportunity to leave the selected route 100 (apart from the confirmation points associated with particular maneuver points). Each set of confirmation points has a first confirmation point 170, 172 and a second confirmation point 180, 182.

Again, as will be explained in more detail below, after reaching a first confirmation point 170, 172, the navigation unit 22 then monitors the current location of the navigation unit 22 for a predetermined time period or predetermined measured distance traveled until the navigation unit 22 reaches the associated second confirmation point 180, 182. By passing through a first confirmation point 170, 172 and then passing through an associated second confirmation point 180, 182, respectively, the navigation unit 22 knows that the user is still traversing to its destination point. However, when the navigation unit 22 passes through a first confirmation point 170, 172 but fails to pass through an associated second confirmation point 180, 182, respectively, within a predetermined time period or predetermined measured distance traveled, the navigation unit 22 knows that the user has gone off course. If this occurs, the navigation unit 22 may then provide a warning to the user.

For a destination point, the server 40 may generate data representative of the destination point 104 such as the type of point (i.e. destination point) and a set of coordinates that will inform the navigation unit 22 that it has reached its destination. In addition, the server 40 may generate and attach certain token numbers. The token numbers would be representative of a string of voice or text words and phrases to be outputted to the user of the navigation unit 22 when the user of the navigation unit 22 reaches the destination point 104. For example, when the user of the navigation unit 22 reaches the destination point 104 a voice or text message may state: “You are arriving at your destination.” Alternatively, the navigation unit 22 may be configured to automatically play a predetermined termination message when the user reaches the destination point.

A further function of the service center 24 is to transmit or send the data associated with certain determined points to the navigation unit 22. In one embodiment, the transmitted data for each point may include items such as the type of point, a set of coordinates, and any associated messages (if needed). The associated messages may be represented in terms of token numbers as further described below. The associated messages may also be included in an attached voice file, such as an MP3 file, although the use of token numbers is preferred because it reduces the amount of data transmitted to the navigation unit 22. Some navigation units 22 may also be configured to render speech instructions using text-to-speech technology. In this case, it may be appropriate to just send the actual text to be spoken along with the coordinates of a particular point. This would allow any words to be spoken from the recited text instead of prerecorded messages. Other types of data that may be associated with a particular point may include a road heading, a sequence number, a street name, or graphic representation of the maneuver. The server 40 may encode the information into a digital message and transmit or send the data to the navigation unit 22 by a wireless communication.

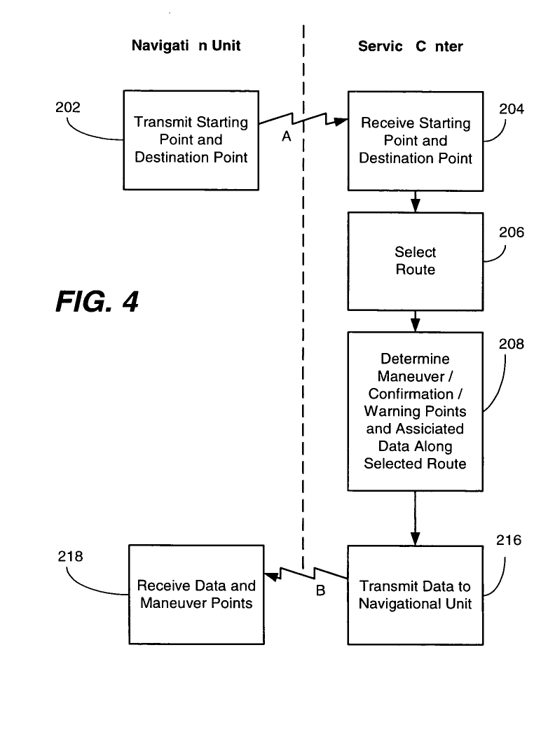

FIG. 4 illustrates a summary of the operation and interaction between the navigation unit 22 and the service center 24. In block 202, the navigation unit 22 transmits a starting point and a destination point to the service center 24. This has been previously described as being either a voice call or a wireless data transmission. Note that while the destination point is transmitted at the beginning of the trip, it may be updated by either a third party or the traveler at any time. For example, if the traveler begins his route heading towards the third party's home, the location may change depending upon travel time. Either the traveler or the third party may determine that they need to rendezvous at a restaurant rather than home to save time. As such, either party may update the destination, in which case all associated steps would recalibrate for the new destination.

In block 204, the service center 24 receives the starting point and the destination point from the navigation unit 22. This has been previously described as being received by an operator and inputted to the server 40 or directed inputted to the server 40 by a digital transmission. After the service center 24 receives the starting point and the destination point, in block 206, the service center 24 may select a route 100. In block 208, the service center 24 determines a set of maneuver points (such as points 110, 112, 114, 116) along the selected route 100. Those of ordinary skill in the art having the benefit of this disclosure will appreciate that selecting a route 100 (in block 206) could be merged or done in conjunction with the determination of the maneuver points.

Referring to FIG. 5, the navigation unit 22 will now be described in more detail. In one embodiment, the navigation unit 22 may be positioned in a vehicle 38, although the navigation unit described herein could be used in other ways such as in personal navigation systems in phones or PDAs. At the heart of the navigation unit 22 is a microcomputer 60. The navigation unit 22 may further include a wireless communication device 62, a GPS module 64, a memory 66, a memory 68 to store data on points downloaded from the service center 24, an on/off button 70 to activate/deactivate the system, and a microphone 72 and output 74 for hands-free operation.

In one embodiment, the wireless communication device 62 includes a transmitter to transmit cellular wireless communications such as AMPS, CDMA, GSM or TDMA. The wireless communication device 62 may also be configured to transmit by other wireless communications such as a satellite communication. The wireless communication device 62 includes a receiver to receive and decode the digital data associated with the points sent or otherwise transmitted by the service center 24. The receiver may be configured to receive digital cellular communications such as CDMA, GSM or TDMA. The receiver may also be configured to receive other types of wireless communications such as those transmitted by satellites.

The received data associated with each point is stored in a memory 68. As will be explained further below, the microcomputer 60 may then use the received and stored data in memory 68 to provide a meaningful navigation experience to the user of the navigation unit 22.

The navigation unit 22 may further include sensors 76 or inputs from various sensors already existing on the vehicle 38. The types of sensors 76 that may be applicable for the navigation unit 22 are a speed sensor and a direction or heading sensor. The information from vehicle sensors may be used in combination with the GPS module to confirm that the navigation unit 22 is properly traversing to the destination point.

The microcomputer 60 may have a processor that implements software stored in memory. In one embodiment, the data associated with each point may be sequentially stored in memory 68. In this context, the term “sequential” means that the points are stored in the order that the vehicle would travel to get to a particular destination point.

The present invention uses the system described above to notify a person of a traveler's estimated time of arrival. The invention is particularly useful for travelers who are new to the area in which they are traveling. For example, when a business person travels to an unfamiliar city and rents a car, it is often desirable for the business person to notify the party he is meeting as to when he will be arriving. If the business person gets in an unfamiliar car, in an unfamiliar town, going to an unfamiliar location, he will have absolutely no idea as to when he will be arriving. Thus, the present invention provides a system and method for notifying a third party of the traveler's estimated time of arrival.

The present invention uses a variety of criteria in calculating the estimated time of arrival, including the traveler's position, the traveler's velocity, the distance remaining to be traveled, current traffic information and current weather information. The traveler determines when the third party will be notified, and how often renotifications will occur. The system then notifies the third party, by telephone call, text page, e-mail or other communications means as to when the traveler will arrive.

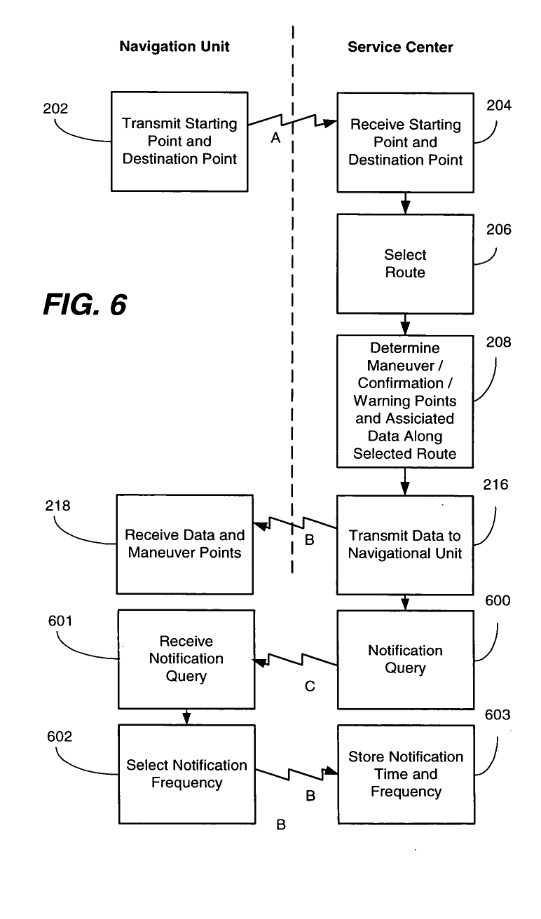

As stated, in the preceding paragraph, the traveler may determine when and how often the system will notify the third party of the traveler's estimated time of arrival. Referring now to FIG. 6, illustrated therein is a summary of the operation and interaction between the navigation unit 22 and the service center 24 in accordance with one embodiment of present invention. Specifically, FIG. 6 illustrates just how the traveler notifies the service center 24 as to when and how frequently the third party should be called.

Steps 202-218 are the same as with respect to FIG. 4, and recite how the traveler enters the starting point and destination point, as well as just how the service center 24 determines the plurality of points along the selected route. Steps 600-603 recite how the traveler's notification of when and how often to call the third party.

Upon transmitting the data points associated with the traveler's selected route to the navigation unit 22 at step 216, the service center queries the traveler as to whether he would like to notify a third party at step 600. This may be a simple voice or text message asking, “Would you like to notify a third party of your time of arrival?” The query of step 600 further asks the traveler upon what basis should the number or frequency of notifications be based. The query is received by the navigational unit at step 601.

For example, the notification times and frequency may be based on any one of a set of criteria. One criterion for notifying the third party may be based upon the points selected along the traveler's route 100. Recall from the discussion of FIG. 3 that the service center generates several points along the desired route 100, including maneuver points 110, 112, 114, 116, instruction points 120, 122, 124, 126, warning points, 130, 132, 134, 136, preparation points, 140, 142, 144, 146 and confirmation points 150, 152, 154, 156, 160, 162, 164, 166. The user may select any of these predetermined points as notification or renotification points.

This particular criterion has advantages in that the third party is updated each time the traveler approaches or passes through things like maneuvers, which often involve intersections. If any one intersection, for instance, is particularly congested, by picking a confirmation point as the notification point, the third party will get an updated time once the traveler has cleared the maneuver. Note that any of these points, or combinations of these points, may be selected by the traveler through the navigation unit 22 at step 602, presuming that the traveler desires to notify the third party as to his estimated time of arrival.

A second, alternative criterion for notifying the third party may be based upon a particular frequency. For example, rather than choosing points as noted in the preceding paragraph, the traveler may elect to have the third party called at a predetermined frequency, every 10 minutes for instance. In doing such, the third party would be notified of the traveler's estimated time of arrival by a series of equally spaced notifications throughout the traveler's trip, each with an updated estimated time of arrival. This criterion has advantages in that the third party may expect a notification at a specific time, updating them on the traveler's progress.

A third, alternative criterion for notifying the third party may be passed upon user defined points. Rather than selecting points selected by the service center, the traveler may prefer to select his own points, which may correspond to locations or landmarks that the user considers to be personally significant. For example while traveling from New York to Massachusetts, the user may elect to have the third party notified when he crosses the state line of New York, which may not correspond to any of the maneuver, warning, instruction, preparation or confirmation points. This particular criterion has advantages in that people often estimate time of travel based upon such landmarks. As such, the third party may have traveled the particular route before, and may have a reasonable idea of the particular traffic conditions and travel times associated with the remaining commute. Thus, a notification at such a point may provide the third party to an estimated time of arrival that is easier to relate to.

A fourth criterion with which to notify the third party is based upon a geometric division of the preselected route based upon distance. For example, the division may be at the half-way point, one-third-way point, quarter-way point, etc. This particular criterion has advantages in that the travel time and travel distance may be proportional in cases where the traveler travels substantially along a single road, at a constant speed. In such cases, the traveler would be notifying the third party when the estimated remaining time correlated to the estimated remaining distance.

A fifth criterion with which to notify the third party is based upon remaining travel time. For example, the user may elect to notify the third party when there are 30 minutes of travel time remaining, or 10 minutes of time remaining, etc. This criterion is especially advantageous when the arrival of the traveler is intended to correspond with a time sensitive event, like dinner. If the traveler is a son or daughter heading home to eat with their parents, the parents would be able to correlate dinner preparation and cooking times with the traveler's progress along the selected route.

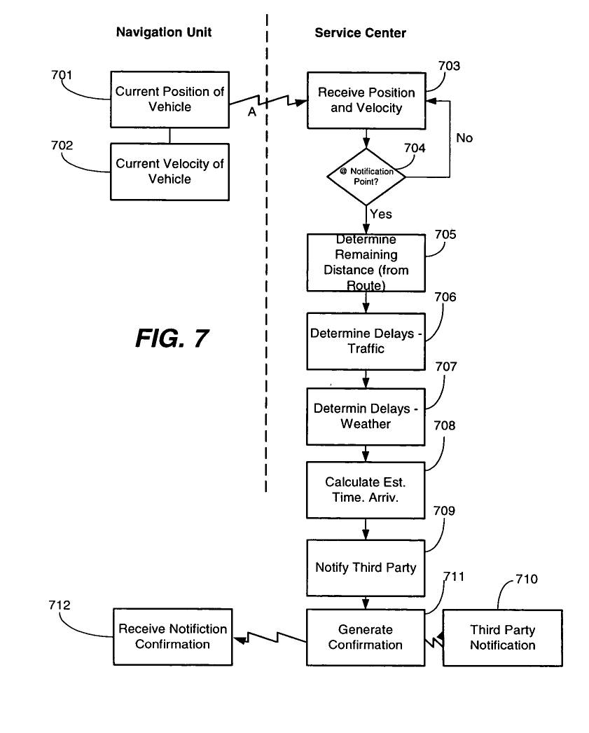

A sixth criterion with which to notify the third party is based upon changes in the estimated time of arrival. As will be seen below with the discussion of FIG. 7, the system is able to add delays to the estimated time of arrival due to traffic delays. If a person is moving along well on the roads, and suddenly comes upon a new accident, his travel time may change from minutes to hours. As such, one criterion would be to notify the third party whenever the estimated time of arrival changes by more than a predetermined amount. For example, if the time gets extended by more than 15 minutes, the traveler may want the third party to receive an updated notification.

A seventh criterion with which to notify the third party is based upon a fixed time. For example, if the traveler is trying to get to a prearranged appointment at a specific time, it may be desirable to have the system notify the third party relative to that time. If, for instance, the prearranged appointment is at 10 AM, it may be desirable to notify the third party based upon this time, e.g., 15 minutes prior, 10 minutes prior, 5 minutes after, 20 minutes after, etc.

It will be clear to those of ordinary skill in the art, having the benefit of this disclosure, that other criteria, in addition to those listed here, may also be used to determine when and how often the third-party notifications may take place. Additionally, combinations of these criteria may be used as well. Once the time and frequency are selected at step 602, they are transmitted from the navigation unit 22 to the service center 24. They are stored by the service center at step 603.

Referring now to FIG. 7, illustrated therein is one embodiment of the method of determining the estimated time to arrival in accordance with the invention. At step 701 the current position of the vehicle is determined by way of the GPS module 64 (shown in FIG. 5) of the navigation unit. At step 702, the velocity is determined by way of the sensors 76 (shown in FIG. 5) of the navigation unit. These parameters are transmitted to the service center 24 and are received at step 703. The parameter determination and transmission to the service center 24 could be done periodically, continually or just prior to the predetermined estimated time of arrival notification, as selected by the traveler.

Step 704 is optional and will be used when the parameter determination and transmission is done either periodically or continually. At step 704, the service center 24 checks to see whether the traveler is at a notification point. If so, then the service center proceeds to step 705. If not, then the service center returns to step 703 to await further receipts of data. If the transmission occurs in correlation to the estimated time of arrival notification point, step 704 may be omitted.

At step 705, the remaining distance along the route 100 is determined. This determination is based upon the traveler's location, as determined at step 701. This distance may be based upon the original route 100, or may have changed. Changes would occur when the service center 24 alters the traveler's route based upon traffic delays or other situations which may delay or prevent the traveler from continuing along the selected route 100.

At step 706, the service center 24 determines what delays are present due to current traffic conditions. The delay is calculated from the data received from the traffic database 50 of the service center 24. The ability to add in a traffic delay is a distinct advantage over prior art systems, in that a 10 minute ride, for example in Los Angeles, may take anywhere from 10 minutes to 2 hours, depending upon the traffic. When the traveler selects multiple notification points, the estimated time of arrival will continually be updated and changed due to traffic delays. Thus, in a situation where traffic is moving well and then suddenly stops due to an accident, the third party will receive an updated notification once the delay is added to the estimated time of arrival.

At step 707, weather delays may be optionally added as well. It is known that heavy rain tends to slow down traffic on highways and thoroughfares, as does heavy fog or bright sunrises and sunsets. As such, when this weather information is stored in the traffic and weather database 50, appropriate delays may be added during this step.

At step 708, the estimated time of arrival is calculated. As will be explained in the following paragraphs, one way to calculate this estimated time of arrival, which considers all past events, is by way of a Kalman filter. The distance divided by velocity, along with delays due to intersections, traffic, weather and other conditions are all considered by the filter to yield a current estimated time of arrival for the traveler.

At step 709, the notification is sent to the third party. The notification may be through the cellular network (described above) to a mobile telephone, or may take other telecommunications forms, including textual paging, land-line telephone calls, facsimile transmissions, e-mails, two-way radio communications and the like. An audible notification message is generally of the form, “Mr./Ms. (Traveler's name) will be arriving in approximately XX minutes . . . ” A textual or printed message appears as follows: “Message from (Traveler's name): Estimated time of arrival to your location is XX minutes . . . ” When there has been an increase in the estimated time of arrival of more than a predetermined amount, and additional message may be added, that indicates the cause of the increase. For example, “Mr. (Traveler's name) has been delayed due to a fender bender at Spaghetti Junction.” The third party receives the message at step 710.

At step 711, the system optionally generates a confirmation message for the traveler. For example, the navigation unit may provide to the traveler an audible or visual message saying, “Mr. (Third Party's name) has been notified that your estimated time of arrival is XX minutes.” Another message might read, “Mr. (Third Party's name) has been notified of the new delay due the fender bender at Spaghetti Junction.” Confirmation of the notification is received by the traveler at step 712.

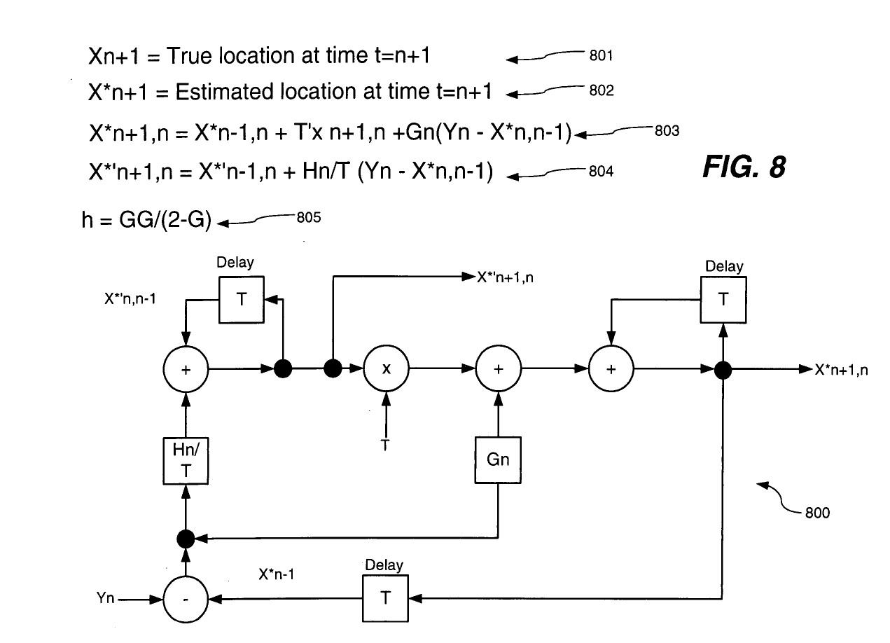

Referring now to FIG. 8, illustrated therein is one method for calculating the estimated time of arrival as recited in step 708 of FIG. 7. FIG. 8 illustrates one form of a Kalman filter. A Kalman filter is a recursive data processing algorithm. Kalman filters are well suited to the present invention because they are capable of incorporating all information available for continually updating and estimation in linear systems. As such, a Kalman filter may include as inputs the traveler's velocity, position, and distance to be traveled, as well as delays due to traffic and weather.

As Kalman filters are well known in the art, only an exemplary discussion will be provided here, although it will be clear to those of ordinary skill in the art that additional data could be included as inputs and processed through the Kalman filter. For discussion purposes, the filter 800 shown in FIG. 8 is known in the art as a Kalman g-h Filter. A Kalman g-h Filter is a two stage process, which means that at any one moment, the measurements of a noisy position and a noisy velocity are incorporated into the filter. The Kalman g-h filter then attempts to find the optimum position and velocity to minimize the noise.

Essentially, in FIG. 8, a position equation 803 and a velocity equation 804 are set up. These equations 803,804, employ a estimated traveler location 802, which is an actual location 801 with some uncertainty in measurement added. The equations 803,804 are linked by variance terms g and h per equation 805. By processing the equations 803,804 through the filter, as shown by the feedback system 800, an estimated velocity 806 and estimated position 807 may be obtained. From these values, an estimated time of arrival may be calculated. Delays due to traffic and weather may also be added, either as time delays, or via the velocity equation 804, as the average velocity of the traveler will be reduced when delays are introduced due to weather or traffic.

While the preferred embodiments of the invention have been illustrated and described, it is clear that the invention is not so limited. Numerous modifications, changes, variations, substitutions, and equivalents will occur to those skilled in the art without departing from the spirit and scope of the present invention as defined by the following claims.

1. A method for notifying a party of a traveler's estimated time of arrival, the method comprising the steps of:
a. providing a navigation unit to the traveler, the navigation unit comprising an input, an output, a wireless communication device and a global positioning systems module;
b. providing a service center, the service center comprising a means for sending and receiving communications to and from the wireless communication device, a server capable of generating a preferred route of travel for the traveler, the preferred rout of travel comprising at least a plurality of points, and a traffic database capable of receiving current traffic information;
c. selecting a predetermined time and frequency of notifying the third party;
d. calculating an estimated time of arrival based upon a position of the traveler, a velocity of the traveler, a distance to be traveled, and a delay due to traffic; and
e. notifying a party of the estimated time of arrival.

2. The method of claim 1, further comprising the step of adding a delay due to weather conditions.

3. The method of claim 3, further comprising the step of generating a confirmation message, wherein the confirmation message indicates that the party has been notified.

4. The method of claim, 1 wherein the time and frequency of notifying the party is based upon at least one criterion selected from the group consisting of maneuver points, instruction points, warning points, preparation points, confirmation points, a predetermined frequency, user defined points, geometric divisions of the route based upon distance, changes in time of travel, remaining time of travel and a predetermined appointment time.

5. The method of claim 4, wherein the notification of the party is made by a means selected from the group consisting of cellular communications, textual paging, land-line telephone calls, facsimile transmissions, e-mails, and two-way radio communications.

6. The method of claim 1, wherein the step of calculating the estimated time of arrival is accomplished with a Kalman filter.

7. A system for notifying a party of a traveler's estimated time of arrival comprising:
a navigation unit, the navigation unit comprising:
i. a microcomputer;
ii. an input coupled to the microcomputer;
iii. an output coupled to the microcomputer;
iv. a wireless communication device coupled to the microcomputer; and
v. a global positioning systems module coupled to the microcomputer;
b. a service center, the service center comprising:
i. a means for sending and receiving communications to and from the wireless communication device coupled to the server;
ii. a server capable of generating a preferred route of travel for the traveler, the preferred route of travel comprising at least a plurality of points, and
iii. a traffic database capable of receiving current traffic information;
wherein a traveler selects a predetermined time and frequency of notifying the party; further wherein the server calculates an estimated time of arrival based upon a position of the traveler, a velocity of the traveler, a distance to be traveled, and a delay due to traffic; and

8. The system of claim 7, wherein the server further generates a confirmation message, wherein the confirmation message indicates that the party has been notified.

9. The system of claim 8, wherein the predetermined time and frequency of notifying the party is base upon at least one criterion selected from the group consisting of maneuver points, instruction points, warning points, preparation points, confirmation points, a predetermined frequency, user defined points, geometric divisions of the route based upon distance, changes in time of travel, remaining time of travel and a predetermined appointment time.

10. The system of claim 9, wherein the notification of the party is made by a means selected from the group consisting of cellular communications, textual paging, land-line telephone calls, facsimile transmissions, e-mails, and two-way radio communications.

11. The system of claim 10, wherein the server calculates the estimated time of arrival by way of Kalman filter.
